(19) United States
(12) Patent Application Publication
(10) Pub. No.: US 2006/0133018 A1
(43) Pub. Date: Jun. 22, 2006

(54) Display and mobile device

(76) Inventor: Tatsumi Okuda, Motosu-shi (JP)

Correspondence Address: MCDERMOTT WILL & EMERY LLP, 600 13TH STREET, N.W., WASHINGTON, DC, 20005-3096, US

(21) Appl. No.: 11/288,426

(22) Filed: Nov. 29, 2005

(30) Foreign Application Priority Data
Nov. 30, 2004 (JP) JP2004-345592

(51) Int. Cl. G06F 1/16; G02F 1/1333

(52) U.S. Cl. 361/681; 349/56; 349/58

(57) ABSTRACT

A display and a mobile device are provided that can prevent damage to the display panel due to impact such as a fall. The display includes: a display panel; an upper metal frame that is disposed on the display panel, and houses the display panel; and a first buffer member that is made of a cushioning material, and is interposed between the upper metal frame and the upper face of the display panel.

### CROSS-REFERENCE TO RELATED APPLICATIONS

The priority application No. JP2004-345592 upon which this patent application is based is hereby incorporated by reference.

### BACKGROUND OF THE INVENTION

1. Field of the Invention

The present invention relates to a display and a mobile device, and more particularly, to a display that has a display panel, and a mobile device that includes the display.

2. Description of the Background Art

An example of a conventional display having a display panel is disclosed in Japanese Unexamined Patent Publication No. 2004-29663. More specifically, Japanese Unexamined Patent Publication No. 2004-29663 discloses a liquid crystal display (LCD) unit that has the edge portion of a liquid crystal panel (a display panel) interposed between a metal bezel (an upper frame) and a metal center chassis. In such a structure having a liquid crystal panel interposed between a metal bezel and a metal center chassis, however, the liquid crystal panel is brought into contact with the metal bezel and the metal center chassis when impact is applied to the liquid crystal display unit due to a fall or the like. As a result, the liquid crystal panel is damaged.

Also, displays (LCD units) each having an upper metal frame and a resin frame bonded to each other with two-sided tape have been known. In such a conventional display, the resin frame serves to secure the display panel. FIG. 18 is a perspective view of a conventional LCD unit that has an upper frame and a resin frame bonded to each other with two-sided tape. FIG. 19 is an exploded perspective view of the conventional LCD unit shown in FIG. 18. FIGS. 20 through 22 illustrate the structure of the conventional LCD unit shown in FIG. 18. Referring to FIGS. 18 through 22, the structure of a conventional LCD unit 140 is described.

As shown in FIG. 18, the conventional LCD unit 140 includes an upper frame 101 and a lower frame 102 that are made of metal, an upper deflecting plate 103 that is disposed inside the upper frame 101 and the lower frame 102, and a panel flexible printed circuit board (a panel FPC board) 104. The panel FPC 104 of the LCD unit 140 has a connector inserting portion 104b connected to a connector portion 131 of a printed circuit board 130 of a mobile phone handset.

As shown in FIG. 19, the lower frame 102 includes a bottom face portion 102a and four side face portions 102b that extend upward from the four sides of the bottom face portion 102a. The side face portions 102b have protruding portions 102c protruding outward. A notch portion 102d is formed in the side face portion 102b on the side to which the panel FPC board 104 is to be attached. Further, a reflective sheet 105 is disposed above the bottom face portion 102a of the lower frame 102. A resin frame 106 having an opening 106a at the bottom is provided above the reflective sheet 105. In the resin frame 106, a FPC inserting portion 106b through which the panel FPC board 104 is to be inserted is formed at the location corresponding to the notch portion 102d of the lower frame 102.

Inside the resin frame 106, a light guide plate 108 for guiding the light from light emitting diodes (LEDs) 107 (see FIG. 22) to the entire panel, and two lens sheets 109 are stacked in this order from the bottom, as shown in FIGS. 21 and 22. The lens sheets 109 transmit light upward from the light guide plate 108, and also concentrate the light. A diffusion sheet 110 is provided above the lens sheets 109. This diffusion sheet 110 transmits light upward from the lens sheets 109, and also diffuses the light. As shown in FIG. 22, a backlight flexible printed circuit board (a backlight FPC board) 111 is bonded to the upper face of the light guide plate 108 with two-sided tape (not shown). The backlight FPC board 111 has an external connecting portion that protrudes outward from the FPC inserting portion 106b of the resin frame 106. A connector inserting portion 111a (see FIG. 19) is formed at the edge of the external connecting portion. The backlight FPC board 111 also has the LEDs 107 that emit light to the light guide plate 108. The LEDs 107 are disposed in such a manner as to emit light toward the light guide plate 108.

As shown in FIG. 19, a black adhesive layer 112 having an opening 112a is bonded to the peripheral portion along the edges of the upper face of the diffusion sheet 110. This adhesive layer 112 covers the peripheral portion along the edges of the lens sheets 109, and functions to block the light traveling upward from the peripheral portion at the edges of the lens sheets 109. As shown in FIGS. 21 and 22, a lower deflecting plate 113 is disposed above the diffusion sheet 110 and the adhesive layer 112. Further, a lower glass substrate 114 and an upper glass substrate 115 that are arranged to interpose liquid crystal are provided above the lower deflecting plate 113. Although not shown, a thin-film transistor is formed on the lower glass substrate 114. The glass substrates 114 and 115, together with the liquid crystal and the thin-film transistor, constitute a display panel. As shown in FIG. 22, the lower glass substrate 114 has a protruding portion 114a protruding from the upper glass substrate 115 toward the FPC inserting portion 106b of the resin frame 106. The upper deflecting plate 103 is further disposed on the upper glass substrate 115.

Further, a driver IC (integrated circuit) 116 for driving the display panel and the panel FPC board 104 are mounted onto the upper face of the protruding portion 114a of the lower glass substrate 114, as shown in FIGS. 19 and 22. The panel FPC board 104 is electrically connected to the driver IC 116.

As shown in FIGS. 18 and 19, an electronic component attaching portion 104a to which electronic components 117 are to be attached is formed at the outward protruding portion of the panel FPC board 104. As shown in FIG. 18, a connector portion 118 to which the connector inserting portion 111a (see FIG. 19) of the backlight FPC board 111 is to be connected is also attached to the electronic component attaching portion 104a. Further, the connector inserting portion 104b is formed at the edge of the electronic component attaching portion 104a.

As shown in FIG. 19, the upper frame 101 made of metal is disposed above the upper deflecting plate 103. The upper frame 101 had an opening 101a at the location corresponding to the display region of the glass substrates 114 and 115. As shown in FIGS. 19 and 20, the upper frame 101 also has an upper face portion 101b, a lower face portion 101c, and four side face portions 101d that extend from the four sides of the upper face portion 101b and the lower face portion 101c toward the lower frame 102. Further, insertion holes 101e through which the protruding portions 102c of the lower frame 102 are to be inserted are formed in the side face portions 101d of the upper frame 101. A notch portion 101f is also formed at the location of the side face portion 101d corresponding to the notch portion 102d of the lower frame 102. By virtue of the opening formed with the notch portion 102d of the lower frame 102 and the notch portion 101f of the upper frame 101, the panel FPC board 104 and the backlight FPC board 111 protrude outward, as shown in FIG. 18. Further, one side of two-sided tape 119 adheres to the lower face portion 101c of the upper frame 101, as shown in FIG. 20. The other side of the two-sided tape 119 adheres to the resin frame 106 and the glass substrate 115, as shown in FIG. 21.

In the conventional LCD unit 140 illustrated in FIGS. 18 through 22, however, the two-sided tape 119 adhering to the lower face portion 101c of the upper frame 101 made of metal and the glass substrate 115 does not have a shock absorbing function. Therefore, when impact caused by a fall or the like is applied to the upper metal frame 101 of the LCD unit 140, the impact is directly transmitted to the glass substrate 115. As a result, the glass substrate 115 (the display panel) is often broken or damaged.

### SUMMARY OF THE INVENTION

A general object of the present invention is to eliminate the above disadvantages. A more specific object of the present invention is to provide a display and a mobile device that can prevent damage to the display panel due to impact caused by a fall or the like.

So as to achieve the above objects, a display in accordance with a first aspect of the present invention includes: a display panel; an upper metal frame that is disposed on the display panel, and houses the display panel; and a first buffer member that is made of a cushioning material, and is interposed between the upper metal frame and the upper face of the display panel.

In the display in accordance with the first aspect, the first buffer member made of a cushioning material is disposed between the upper frame and the display panel, as described above. Accordingly, even when impact caused by a fall or the like is applied to the upper metal frame constituting the outer frame, the first buffer member softens the impact, and the softened impact is transmitted to the display panel. Thus, damage to the display panel can be prevented. Furthermore, the first buffer member is made of a cushioning material. Accordingly, the first buffer member can have the shock absorbing function.

A mobile device in accordance with a second aspect of the present invention includes the above described display in accordance with the first aspect. With this structure, a mobile device equipped with a display that prevents damage to the display panel due to impact from a fall or the like can be obtained.

A display in accordance with a third aspect of the present invention includes: a display panel; an upper metal frame that is disposed on the display panel, and houses the display panel; a first electronic component that is attached to the surface of the display panel; and a buffer member that is made of a cushioning material, and is disposed at a facing portion of the upper metal frame facing the upper face of the first electronic component.

In the display in accordance with the third aspect, the buffer member made of a cushioning material is provided at the portion of the upper metal frame facing the upper face of the first electronic component. Accordingly, even when the first electronic component nears the upper metal frame upon impact caused by a fall or the like, the buffer member can soften the impact on the first electronic component. Thus, damage to the first electronic component can be prevented.

### BRIEF DESCRIPTION OF THE DRAWINGS

FIG. 1 is a perspective view of the entire structure of a LCD unit in accordance with an embodiment of the present invention;

FIG. 2 is a side view of the LCD unit in accordance with the embodiment shown in FIG. 1, where the LCD unit is mounted to a printed circuit board of a mobile phone handset;

FIG. 3 is an exploded perspective view of the LCD unit in accordance with the embodiment shown in FIG. 1;

FIG. 4 is a perspective view illustrating the upper frame and the buffer member of the LCD unit in accordance with the embodiment shown in FIG. 1;

FIG. 5 is a plan view illustrating the upper frame and the buffer member of the LCD unit in accordance with the embodiment shown in FIG. 1;

FIG. 6 is a cross-sectional view of the LCD unit, taken along the line 100-100 of FIG. 1;

FIG. 7 is a cross-sectional view of the LCD unit, taken along the line 200-200 of FIG. 1;

FIG. 8 is a front view illustrating engagement of the upper frame with the lower frame of the LCD unit in accordance with the embodiment shown in FIG. 1;

FIG. 9 is a cross-sectional view illustrating disengagement of the upper frame from the lower frame of the LCD unit in accordance with the embodiment of the present invention;

FIG. 10 is a perspective view illustrating the upper frame of a LCD unit in accordance with a first modification of the embodiment of the present invention;

FIG. 11 is a cross-sectional view of the LCD unit in accordance with the first modification;

FIG. 12 is a perspective view of a LCD unit in accordance with a second modification of the embodiment of the present invention, where the LCD unit is mounted to the printed circuit board of a mobile phone handset;

FIG. 13 is a side view of the LCD unit in accordance with the second modification of the embodiment shown in FIG. 12, where the LCD unit is mounted to the printed circuit board of a mobile phone handset;

FIG. 14 is a perspective view of a LCD unit in accordance with a third modification of the embodiment of the present invention, where the LCD unit is mounted to a printed circuit board of a mobile phone handset;

FIG. 15 is a side view of the LCD unit in accordance with the third modification of the embodiment shown in FIG. 14, where the LCD unit is mounted to the printed circuit board of a mobile phone handset;

FIG. 16 is a perspective view of a LCD unit in accordance with a fourth modification of the embodiment of the present invention, where the LCD unit is mounted to a printed circuit board of a mobile phone handset;

FIG. 17 is a side view of the LCD unit in accordance with the fourth modification of the embodiment shown in FIG. 16, where the LCD unit is mounted to the printed circuit board of a mobile phone handset;

FIG. 18 is a perspective view of the entire structure of a conventional LCD unit;

FIG. 19 is an exploded perspective view of the conventional LCD unit shown in FIG. 18;

FIG. 20 is a plan view illustrating the upper frame and the two-sided tape of the conventional LCD unit shown in FIG. 18;

FIG. 21 is a cross-sectional perspective view of the conventional LCD unit, taken along the line 300-300 of FIG. 18; and

FIG. 22 is a cross-sectional perspective view of the conventional LCD unit, taken along the line 400-400 of FIG. 18.

### DESCRIPTION OF THE PREFERRED EMBODIMENTS

The following is a description of embodiments of the present invention, with reference to the accompanying drawings.

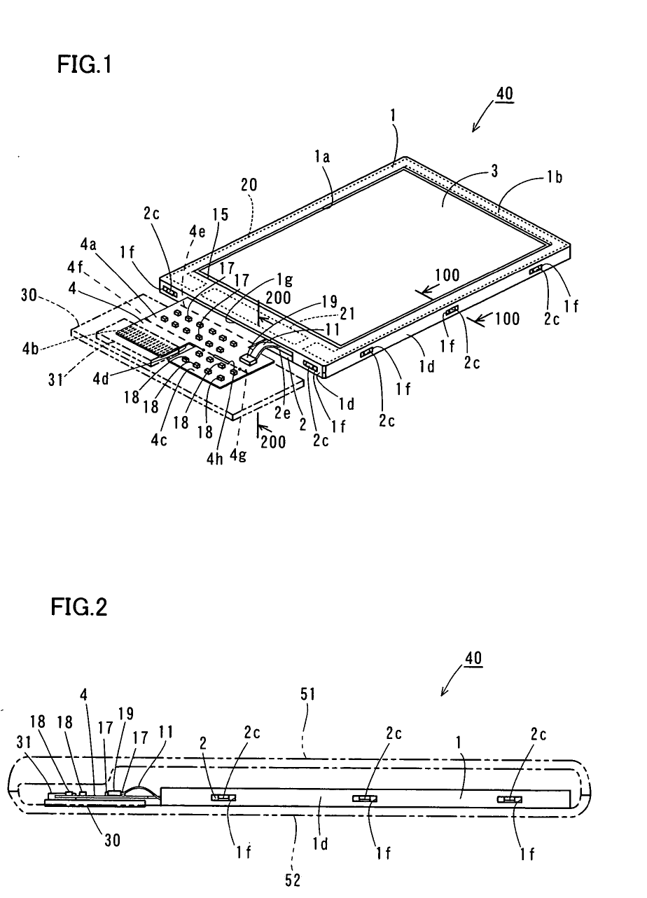

Referring to FIGS. 1 through 8, a LCD unit 40 in accordance with an embodiment of the present invention is described. In this embodiment, the LCD unit 40 is described as an example of the “display” in the claims.

As shown in FIGS. 1 and 2, the LCD unit 40 in accordance with this embodiment includes an upper frame 1 and a lower frame 2 that are plates made of metal, an upper deflecting plate 3 (see FIG. 1) that is disposed inside the upper frame 1 and the lower frame 2, and a panel flexible printed circuit board (panel FPC board) 4. The panel FPC board 4 is an example of the “flexible printed circuit board” in the claims. As shown in FIG. 2, the LCD unit 40 is housed in an upper chassis 51 and a lower chassis 52 of a mobile phone handset, and a connector inserting portion 4b (see FIG. 1) of the panel FPC board 4 of the LCD unit 40 is connected to a connector portion 31 of a printed circuit board 30 of the mobile phone handset.

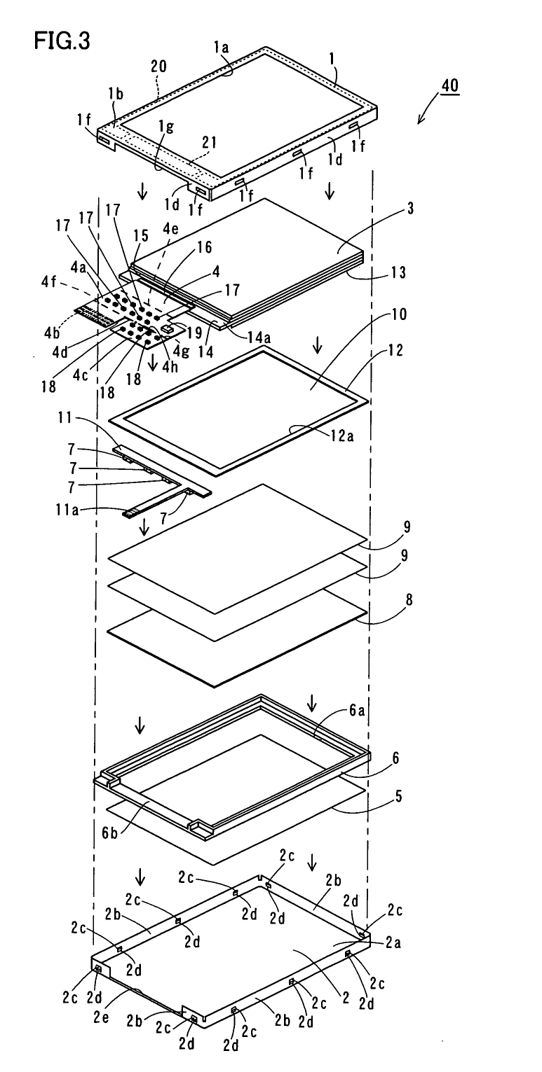

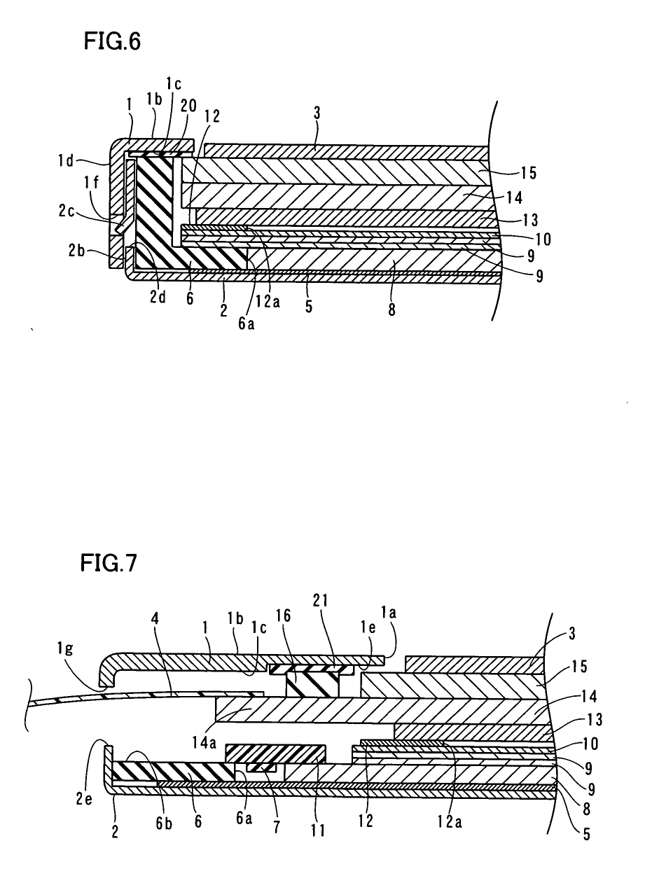

As shown in FIG. 3, the lower frame 2 made of metal includes a bottom face portion 2a and four side face portions 2b that extend upward from the four sides of the bottom face portion 2a. Each of the side face portions 2b has protruding portions 2c extending outward, as shown in FIG. 6. The protruding portions 2c are to be engaged with insertion holes If of the upper frame 1.

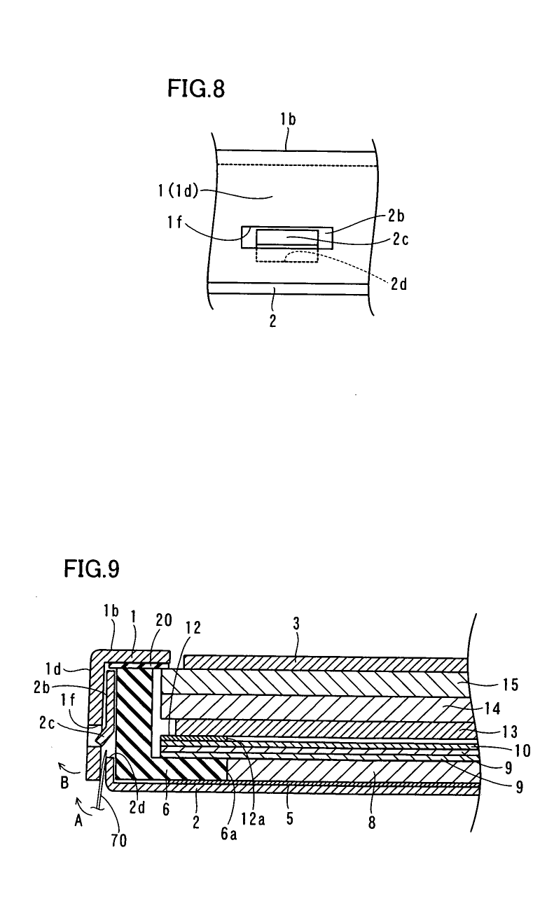

In this embodiment, as shown in FIGS. 6 and 8, disengaging holes 2d that extend downward by a predetermined length from the lower portions of the respective protruding portions 2c are formed in the side face portion 2b of the lower frame 2. The disengaging holes 2d are formed at the same time as the formation of the protruding portions 2c on the side face portions 2b, and are produced by downwardly widening the holes formed in the side face portions 2b when the protruding portions 2c are formed. As shown in FIG. 3, a notch portion 2e is formed in the side face portion 2b on the side at which the panel FPC board 4 is to be disposed.

A reflective sheet 5 is disposed over the bottom face portion 2a of the lower frame 2. A resin frame 6 having an opening 6a at the bottom is disposed on the reflective sheet 5. In the resin frame 6, a FPC inserting portion 6b through which the panel FPC board 4 is to be inserted is formed at the portion corresponding to the notch portion 2e of the lower frame 2.

Inside the resin frame 6, a light guide plate 8 for guiding the light from LEDs 7 (later described, see FIG. 7) to the entire panel and two lens sheets 9 are disposed in this order from the bottom, as shown in FIGS. 6 and 7. The lens sheets 9 transmit light upward from the light guiding plate 8, and have the function of concentrating the light. Also, a diffusion sheet 10 is disposed over the lens sheets 9. The diffusion sheet 10 transmits light upward from the lens sheets 9, and has the function of diffusing the light. As shown in FIG. 7, a backlight flexible printed circuit board (backlight FPC board) 11 is attached to the upper face of the light guide plate 8 with two-sided tape (not shown). The backlight FPC board 11 has an external connecting portion that extends outward from the FPC inserting portion 6b of the resin frame 6. A connector inserting portion 11a (see FIG. 3) is provided at the edge of the external connecting portion. The backlight FPC board 11 also has LEDs 7 (four of them in this embodiment) that emit light to the light guide plate 8. The four LEDs 7 are arranged so as to emit light to the light guide plate 8.

As shown in FIG. 3, a black adhesive layer 12 having an opening 12a is bonded to the peripheral regions along the edges of the upper face of the diffusion sheet 10. The adhesive layer 12 is disposed to cover the peripheral portions along the edges of the lens sheets 9, and has the function of blocking the light traveling upward from the peripheral portions of the edges of the lens sheets 9. As shown in FIGS. 6 and 7, a lower deflecting plate 13 is disposed over the diffusion sheet 10 and the adhesive layer 12. A lower glass substrate 14 and an upper glass substrate 15 that have liquid crystal interposed between them are disposed over the lower deflecting plate 13. A thin-film transistor (not shown) is formed on the lower glass substrate 14. The glass substrates 14 and 15 including the liquid crystal and the thin-film transistor, constitute a display panel. As shown in FIG. 7, the lower glass substrate 14 has a protruding portion 14a protruding from the upper glass substrate 15 toward the FPC inserting portion 6b of the resin frame 6. The upper deflecting plate 3 is disposed over the region corresponding to the display region of the glass substrates 14 and 15.

As shown in FIGS. 3 and 7, a driver IC 16 for driving the display panel and the panel FPC board 4 are attached onto the upper face of the protruding portion 14a of the lower glass substrate 14. The driver IC 16 is an example of the “first electronic component” in the claims. The panel FPC board 4 is electrically connected to the driver IC 16.

In this embodiment, as shown in FIG. 3, the panel FPC board 4 has an electronic component attaching portion 4a to which electronic components 17 are to be attached, a connector inserting portion 4b, and an electronic component attaching portion 4c to which electronic components 18 are to be attached. Also, a connector portion 19 to which the connector inserting portion 11a (see FIG. 3) of the backlight FPC board 11 is to be connected is attached to the electronic component attaching portion 4a. Further, a slit 4d is formed between the connector inserting portion 4b and the electronic component attaching portion 4c, so that the connector inserting portion 4b and the electronic component attaching portion 4c can be bent independently of each other. The electronic components 17 are an example of the “second electronic component” in the claims, and the electronic components 18 are an example of the “third electronic component” in the claims. The electronic component attaching portion 4a is an example of the “first electronic component attaching portion” in the claims, and the electronic component attaching portion 4c is an example of the “second electronic component attaching portion” in the claims.

In this embodiment, the panel FPC board 4 further has a bending portion 4e that is formed on the side of the glass substrate 14, a bending portion 4f that is formed between the electronic component attaching portion 4a and the connector inserting portion 4b, and a bending portion 4g that is formed between the electronic component attaching portion 4a and the electronic component attaching portion 4c. The bending portion 4g has a bending hole 4h that facilitates bending of the bending portion 4g. The bending portion 4e is an example of the “first bending portion” in the claims, the bending portion 4f is an example of the “second bending portion” in the claims, and the bending portion 4g is an example of the “third bending portion” in the claims.

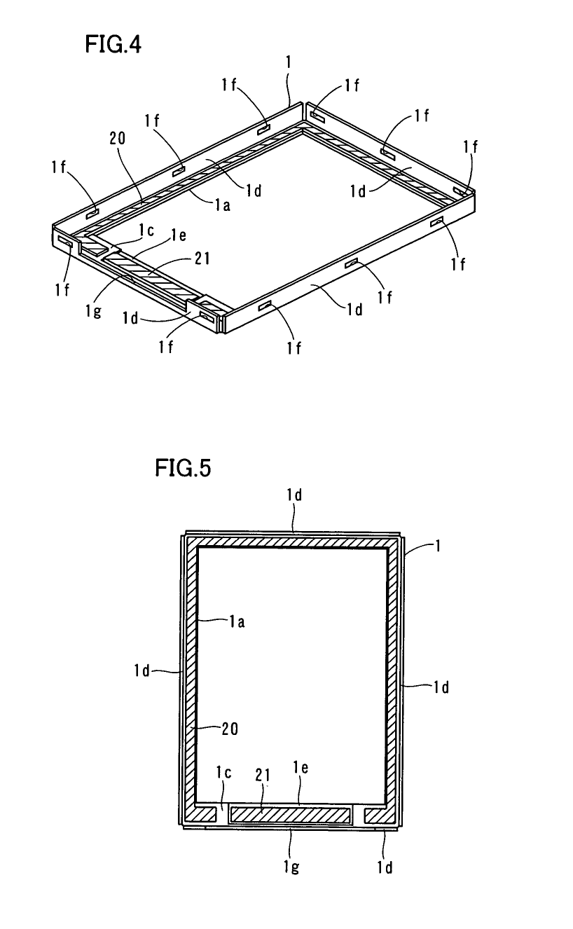

The upper frame 1 made of metal with a thickness of approximately 0.4 mm is disposed on the upper deflecting plate 3. The upper frame 1 has an opening 1a at the location corresponding to the display region of the glass substrates 14 and 15. As shown in FIGS. 3 through 5, the upper frame 1 includes an upper face portion 1b (see FIG. 3), a lower face portion 1c, and four side face portions 1d that extend from the four sides of the upper face portion 1b and the lower face portion 1c toward the lower frame 2. As shown in FIGS. 4 and 5, a facing portion 1e that has a concave shape is formed at the portion of the lower face portion 1c facing the driver IC 16. The concave facing portion 1e has a smaller thickness (approximately 0.2 mm) than the thickness of the rest of the upper frame 1 (approximately 0.4 mm). As shown in FIGS. 3 and 4, the insertion holes If to which the protruding portions 2c of the lower frame 2 are to be inserted are formed in the side face portions 1d of the upper frame 1. As shown in FIGS. 3 through 5, a notch portion 1g is formed at the portion of the side face portion 1d corresponding to the notch portion 2e of the lower frame 2. As shown in FIG. 1, the panel FPC board 4 and the backlight FPC board 11 are disposed to protrude outward via the opening that is formed by the notch portion 2e of the lower frame 2 and the notch portion 1g of the upper frame 1.

In this embodiment, a buffer member 20 that is made of a foamed material (a sponge material) having a thickness of approximately 0.1 mm to 0.2 mm is interposed between the upper frame 1 made of metal and the upper faces of the glass substrate 15 and the resin frame 6, as shown in FIG. 6. The buffer member 20 is an example of the “first buffer member” in the claims. As shown in FIGS. 4 and 5, the buffer member 20 is attached to the upper frame 1. More specifically, the buffer member 20 is not attached to the glass substrate 15 and the resin frame 6, and is attached only to the lower face portion 1c of the upper frame 1 with an adhesive layer (not shown). As shown in FIGS. 1, 3, and 5, the buffer member 20 is designed to surround the edges of the upper face of the upper glass substrate 15 constituting the display panel.

In this embodiment, a buffer member 21 that is made of a foamed material (a sponge material) having a thickness of approximately 0.2 mm to 0.3 mm is formed at the facing portion 1e of the upper frame 1 made of metal facing the upper face of the driver IC 16 (see FIGS. 3 and 7), as shown in FIGS. 4 and 5. The buffer member 21 is an example of the “second buffer member” in the claims. This buffer member 21 is disposed so that the upper face of the driver IC 16 bites into the lower face of the buffer member 21, with the upper frame 1 being attached to the structure, as shown in FIG. 7. With this arrangement, even when the driver IC 16 nears the upper frame 1 made of metal upon impact such as a fall, the buffer member 21 can soften the impact on the driver IC 16. Thus, damage to the driver IC 16 can be prevented.

FIG. 9 is a cross-sectional view illustrating disengagement of the upper frame and the lower frame of the LCD unit in accordance with the embodiment. Referring now to FIG. 9, disengagement of the upper frame 1 and the lower frame 2 is described. As shown in FIG. 9, a needle 70 is interposed between a side face portion 1d of the upper frame 1 and a side face portion 2b of the lower frame 2. The needle 70 is also inserted to the corresponding disengagement hole 2d. As each disengagement hole 2d extends downward by the predetermined length from the lower portion of the corresponding protruding portion 2c, the needle 70 can be easily inserted to the disengagement hole 2d. Also, the needle 70 is rotated about the edge of the disengagement hole 2d in the direction of the arrow A in FIG. 9, so as the bend the side face portion 1d of the upper frame 1 in the direction of the arrow B in FIG. 9. Accordingly, each protruding portion 2c of the lower frame 2 can be easily disengaged from each corresponding insertion hole 1f of the side face portions 1d of the upper frame 1.

As described above, the buffer member 20 made of a foamed material is interposed between the upper frame 1 and the glass substrate 15 constituting the display panel in this embodiment. Accordingly, when impact due to a fall or the like is applied to the upper metal frame 1 forming the outer frame, the buffer member 20 softens the impact. The softened impact is transmitted to the glass substrate 15 (or the display panel), so that damage to the glass substrate 15 (or the display panel) can be prevented. Furthermore, being made of a foamed material, the buffer member 20 has the capability of absorbing shock.

Also in this embodiment, the buffer member 20 made of a foamed material is interposed between the upper metal frame 1 and the resin frame 6. Accordingly, when impact due to a fall or the like is applied to the upper metal frame 1 forming the outer frame, the buffer member 20 softens the impact. The softened impact is transmitted to the upper face of the resin frame 6, so that the resin frame 6 can be protected from severe impact.

In this embodiment, the buffer member 20 is not attached to the glass substrate 15, but is attached to the upper frame 1. Accordingly, the upper frame 1, the resin frame 6, and the glass substrate 15 can be readily disassembled without damage to the glass substrate 15, when foreign matters such as dust are removed from the inside of the LCD unit 40. The disassembling is easier than in the case where the upper frame 1 and the glass substrate 15 are bonded to each other with two-sided tape. As the disassembling is easy, reassembling is also easy. Accordingly, the disassembled LCD unit 40 can be readily reused.

It should be understood that the above described embodiment is merely an example in all aspects and does not limit the scope of the present invention. The scope of the present invention is shown by the claims, instead of the above described embodiment. Any modification can be made to the above described embodiment within the spirit and scope of the present invention.

For example, although the present invention is applied to a LCD unit as a display in the above embodiment, it may be applied to any other display such as an organic EL display unit, as long as the display has a display panel.

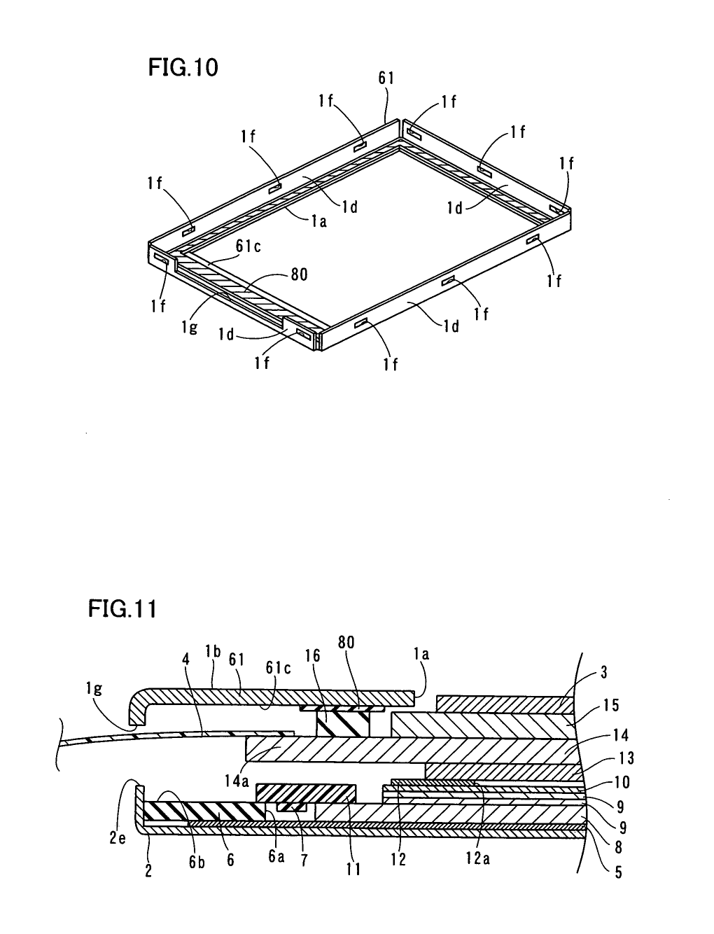

Although the buffer member 20 and the buffer member 21 are employed independently of each other in the above described embodiment, the present invention is not limited to that structure. As in a first modification illustrated in FIGS. 10 and 11, a buffer member 80 that has the buffer member 20 and the buffer member 21 integrally made of the same foamed material may be attached to the lower face portion 61c of an upper metal frame 61. Where the buffer member 20 and the buffer member 21 are formed integrally with each other, the integrated buffer member 80 has a uniform thickness. Therefore, the upper frame 61 does not have a concave portion, unlike the upper frame 1 having the concave facing portion 1e shown in FIGS. 4 and 7. However, it is possible to form a concave portion in the upper frame 61 in the structure with the integrated buffer member 80, as in the structure illustrated in FIGS. 4 and 7.

Although the buffer member 20 and the buffer member 21 are made of a foamed material (a sponge material) as an example of a cushioning material in the above described embodiment, the present invention is not limited to that structure. The buffer members 20 and 21 may be made of another cushioning material such as resin (styrofoam or rubber).

Also, the LCD unit is mounted in a mobile phone handset in the above described embodiment, but the present invention is not limited to that. It is possible to mount the LCD unit in any other mobile device, or even in a device that is not a mobile device.

Also, the four LEDs are employed in the above described embodiment. However, the number of LEDs is not limited to four in the present invention. The number of LEDs may be less than four or more than four. In any case, it is preferable to employ two or more LEDs.

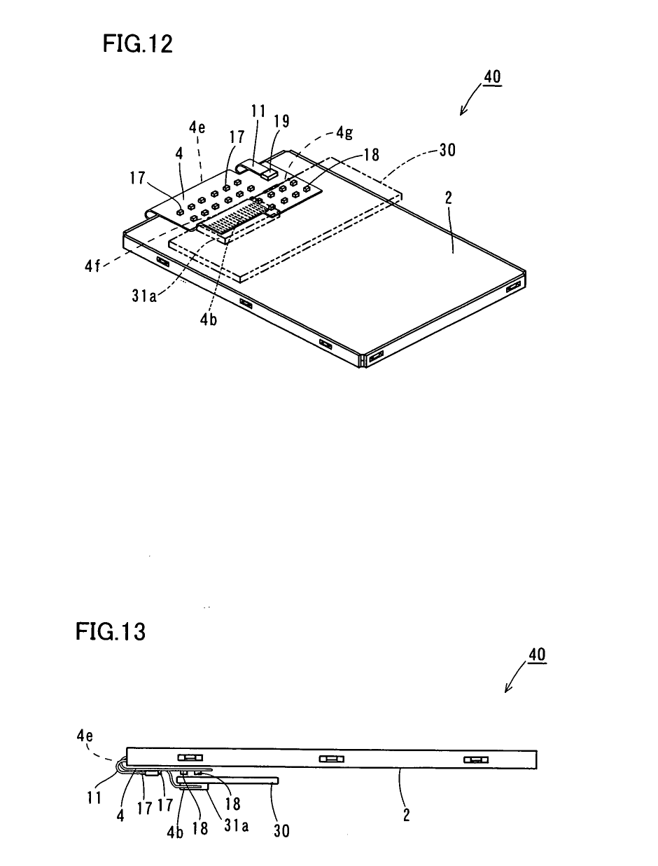

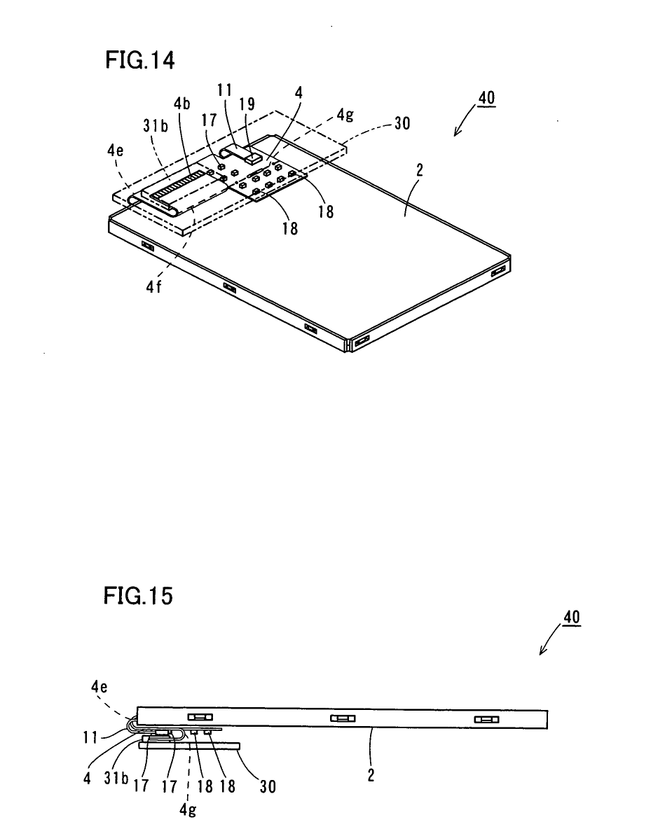

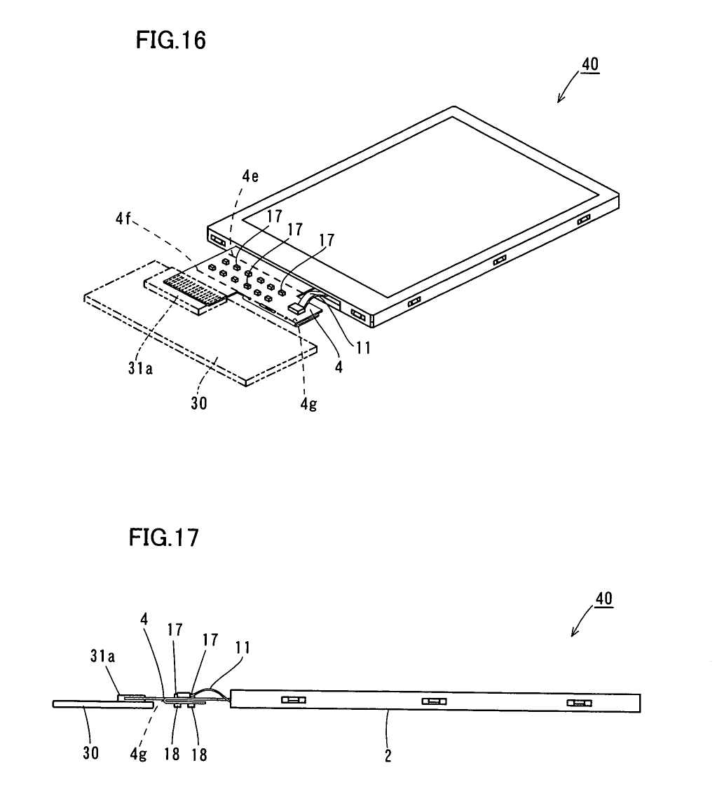

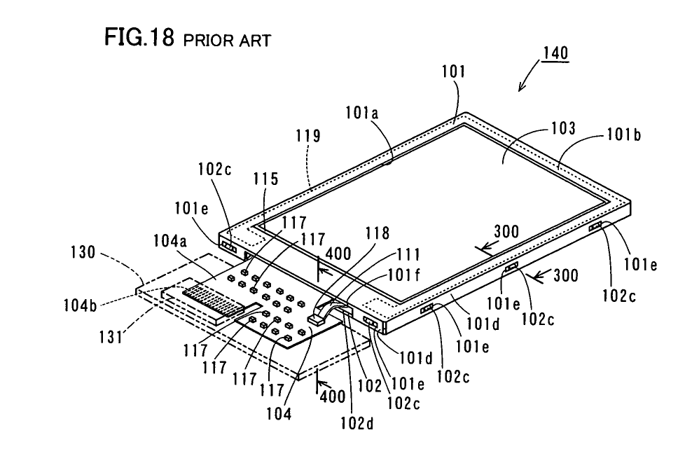

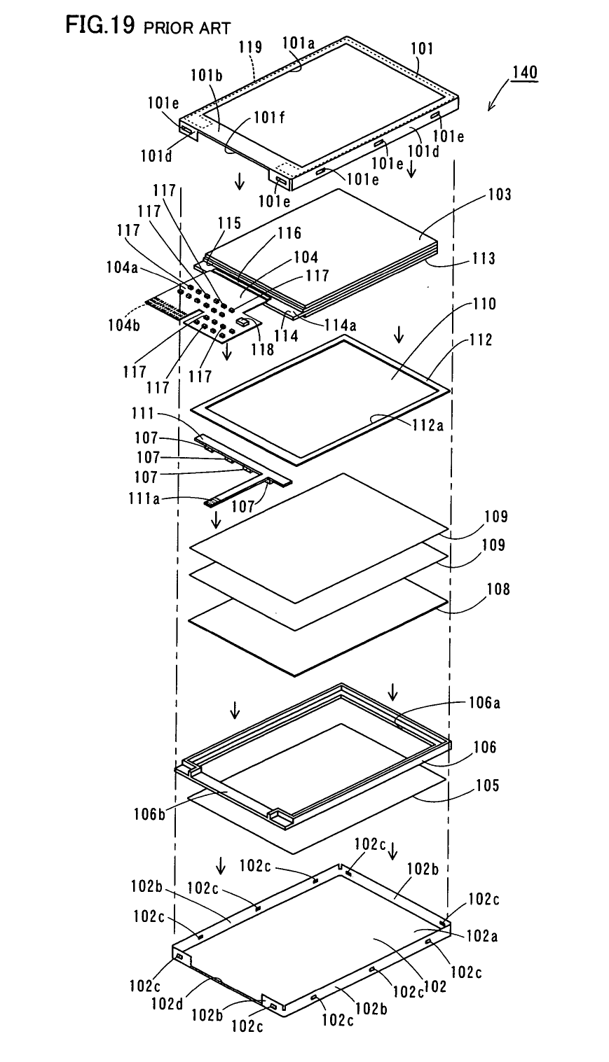

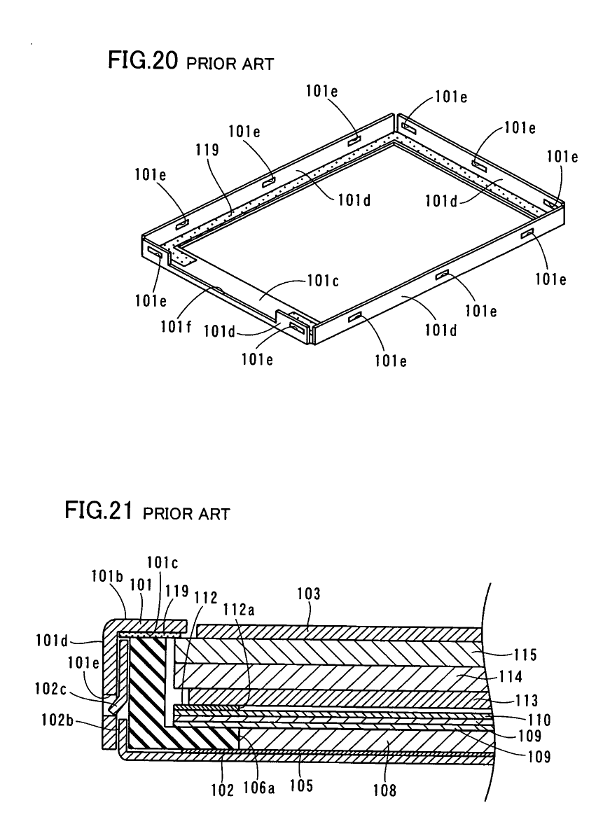

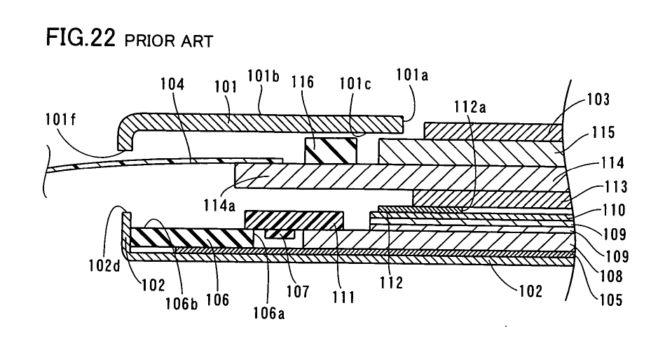

Although the bending portions 4e, 4f, and 4g of the panel FPC board 4 are shown as not being bent in the above embodiment, the present invention is not limited to that structure. FIGS. 12 through 17 illustrate second through fourth modifications of the above embodiment of the present invention. As in the second modification illustrated in FIGS. 12 and 13, the bending portion 4e of the panel FPC board 4 of the LCD unit 40 may be bent, and the connector inserting portion 4b of the panel FPC board 4 extending in the bending direction may be connected to the connector portion 31a of the printed circuit board 30 of a mobile phone handset. In this case, the panel FPC board 4 of the LCD unit 40 may be disposed below the lower frame 2 of the LCD unit 40. As in the third modification illustrated in FIGS. 14 and 15, the bending portions 4e and 4g of the panel FPC board 4 of the LCD unit 40 may be bent, but the bending portion 4f (see FIG. 14) of the panel FPC board 4 may not be bent. In this structure, the panel FPC board 4 can be inserted to a connector portion 31b opposed to the connector portion 31a of the printed circuit board 30 of the mobile phone handset shown in FIGS. 12 and 13. As in the fourth modification illustrated in FIGS. 16 and 17, the bending portions 4e and 4f (see FIG. 16) of the panel FPC board 4 of the LCD unit 40 are not bent, but only the bending portion 4g may be bent. In this structure, the electronic components 17 and 18 can be disposed on and under the panel FPC board 4 of the LCD unit 40. Also, as the bending portion 4g of the panel FPC board 4 of the LCD unit 40 is bent, the electronic component attaching portion 4c is disposed below the electronic component attaching portion 4a. Accordingly, the electronic component attaching portion 4c does not overlap the upper portion of the printed circuit board 30 of the mobile phone handset. Thus, the area that can serve as the circuit region of the printed circuit board 30 of the mobile phone handset can be increased.

Although both the buffer member 20 and the buffer member 21 are employed in the above described embodiment, the present invention is not limited to that structure. Instead, it is possible to employ only either the buffer member 20 or the buffer member 21.

What is claimed is:

1. A display comprising:
a display panel;
an upper metal frame that is disposed on said display panel, and houses said display panel; and
a first buffer member that is made of a cushioning material, and is interposed between said upper metal frame and the upper face of said display panel.

2. The display as claimed in claim 1, further comprising
a resin frame that is disposed inside said upper metal frame, and secures said display panel, wherein
said first buffer member made of said cushioning material is interposed between said upper metal frame and said resin frame.

3. The display as claimed in claim 1, wherein said first buffer member is not attached to said display panel, but is attached to said upper metal frame.

4. The display as claimed in claim 1, wherein said first buffer member surrounds the edge portion of the upper face of said display panel.

5. The display as claimed in claim 1, further comprising:
a first electronic component that is attached to the surface of said display panel; and
a second buffer member that is made of a cushioning material, and is disposed at a facing portion of said upper metal frame facing the upper face of said first electronic component.

6. The display as claimed in claim 5, wherein said first buffer member and said second buffer member are integrally formed of the same cushioning material.

7. The display as claimed in claim 1, further comprising
a lower metal frame that is disposed below said display panel, and houses said display panel, wherein
insertion holes are formed in the side faces of said upper metal frame,
protruding portions to be engaged with the insertion holes of said upper metal frame and disengagement holes extending downward by a predetermined length from lower portions of said protruding portions are formed at the side faces of said lower metal frame.

8. The display as claimed in claim 1, further comprising
a flexible printed circuit board for display panel that is attached to said display panel, and extends from the inside of said upper metal frame to the outside of said upper metal frame, wherein
said flexible printed circuit board comprises a connector inserting portion, a first bending portion that is formed on the side of said display panel, and a second bending portion that is formed between said connector inserting portion and said first bending portion.

9. The display as claimed in claim 8, wherein:
a second electronic component and a third electronic component are attached to said flexible printed circuit board; and
said flexible printed circuit board comprising a first electronic component attaching portion to which said second electronic component is to be attached, a second electronic component attaching portion to which said third electronic component is to be attached, and a third bending portion that is formed between said first electronic component attaching portion and said second electronic component attaching portion.

10. The display as claimed in claim 9, wherein said flexible printed circuit board has a slit that is formed between said connector inserting portion and said second electronic component attaching portion.

11. The display as claimed in claim 1, wherein said cushioning material is formed of a foamed material.

12. A mobile device comprising
a display that comprises:
a display panel;
an upper metal frame that is disposed on said display panel, and houses said display panel; and
a first buffer member that is made of a cushioning material, and is interposed between said upper metal frame and the upper face of said display panel.

13. The mobile device as claimed in claim 12, further comprising
a resin frame that is disposed inside said upper metal frame, and secures said display panel, wherein
said first buffer member made of said cushioning material is interposed between said upper metal frame and said resin frame.

14. The mobile device as claimed in claim 12, wherein said first buffer member is not attached to said display panel, but is attached to said upper metal frame.

15. The mobile device as claimed in claim 12, wherein said first buffer member surrounds an edge portion of the upper face of said display panel.

16. The mobile device as claimed in claim 12, further comprising:
a first electronic component that is attached to the surface of said display panel; and
a second buffer member that is made of a cushioning material, and is disposed at a facing portion of said upper metal frame facing the upper face of said first electronic component.

17. The mobile device as claimed in claim 16, wherein said first buffer member and said second buffer member are integrally formed of the same cushioning material.

18. The mobile device as claimed in claim 12, further comprising
a lower metal frame that is disposed below said display panel, and houses said display panel, wherein
insertion holes are formed in the side faces of said upper metal frame,
protruding portions to be engaged with said insertion holes of said upper metal frame and disengagement holes extending downward by a predetermined length from lower portions of said protruding portions are formed at the side faces of said lower metal frame.

19. The mobile device as claimed in claim 12, further comprising
a flexible printed circuit board for display panel that is attached to said display panel, and extends from the inside of said upper metal frame to the outside of said upper metal frame, wherein
said flexible printed circuit board comprises a connector inserting portion, a first bending portion that is formed on the side of said display panel, and a second bending portion that is formed between said connector inserting portion and said first bending portion.

20. The mobile device as claimed in claim 19, wherein:
a second electronic component and a third electronic component are attached to said flexible printed circuit board; and
said flexible printed circuit board comprising a first electronic component attaching portion to which said second electronic component is to be attached, a second electronic component attaching portion to which said third electronic component is to be attached, and a third bending portion that is formed between said first electronic component attaching portion and said second electronic component attaching portion.

21. The mobile device as claimed in claim 20, wherein said flexible printed circuit board has a slit that is formed between said connector inserting portion and said second electronic component attaching portion.

22. The mobile device as claimed in claim 12, wherein said cushioning material is formed of a foamed material.

23. A display comprising:
a display panel;
an upper metal frame that is disposed on said display panel, and houses said display panel;
a first electronic component that is attached to the surface of said display panel; and
a buffer member that is made of a cushioning material, and is disposed at a facing portion of said upper metal frame facing the upper face of said first electronic component.
